(19) United States
(12) Patent Application Publication
(10) Pub. No.: US 2026/0229418 A1
(43) Pub. Date: Aug. 6, 2026

(54) SEALING MATERIAL FOR CAPACITOR HAVING DISC

(71) Applicant: LG ELECTRONICS INC., Seoul (KR)

(72) Inventor: Gang-Won KWON, Seongnam-si (KR)

(73) Assignee: Sung Nam Electrics IND. Co., Ltd, Seongnam-si (KR)

(21) Appl. No.: 19/149,530

(22) PCT Filed: Nov. 28, 2023
(86) PCT No.: PCT/KR2023/019374

§ 371 Date: Jul. 18, 2025

(30) Foreign Application Priority Data
Jan. 20, 2023 (KR) 10-2023-0008746

(51) Int. Cl. H01G 9/10; F16J 15/02

(52) U.S. Cl. CPC H01G 9/10; F16J 15/022

(57) ABSTRACT

The present invention relates to a sealing material attached to a capacitor, and more specifically, to a sealing material configured to include a disc made of metal, a coated body coated on an outer peripheral surface of the disc, and a hole formed in the coated body and through which a lead wire passes.

This application is a national stage application of International Patent Application No. PCT/KR2023/019374, filed on Nov. 28, 2023, which claims the priority of Korean Patent Application No. 10-2023-0008746 filed on Jan. 20, 2023, which are incorporated herein by reference in their entirety.

### BACKGROUND OF THE INVENTION

### Technical Field of the Invention

At least one embodiment of the invention relates to a sealing material sealing a lower opening of a capacitor, and more specifically, to a sealing material configured to include a disc made of metal, a coated body coated on an outer peripheral surface of the disc, and a hole formed in the coated body and through which a lead wire passes.

### Description of the Related Art

In general, an electrolytic capacitor stores an electrolyte in the form of a liquid, solid, or gel inside a case that serves as a main body, so a sealing material is attached to a lower portion of the capacitor to prevent such electrolyte from leaking to the outside.

The sealing material is manufactured using synthetic rubber and is usually formed in a circular shape according to the appearance of the electrolytic capacitor, and a predetermined number of holes are formed in a center to pass a lead wire of the electrolytic capacitor.

When such electrolytic capacitors are used for high-power applications, there is a concern that the electrolyte may leak out of the case due to the expansion of the electrolyte as a result of the increase in the temperature of the internal electrolyte. Therefore, as shown in FIG. 1 of the sealing material of an aluminum electrolytic capacitor and its manufacturing method of Korean Laid-open Patent Publication No. 10-2010-0123000, a technology is known in which a hole 3 for passing a lead wire is formed in a body 1 of the electrolytic capacitor, and a reinforcing material 2 made of stainless steel material is attached to an upper side of the body 1 to increase the rigidity of the sealing material.

However, the above-described known technology had a disadvantage in that the material of the reinforcing material 2 attached to the upper side of the body 1 itself was stainless steel, so the insulation property with other parts such as lead wires was weak, and in particular, it had a disadvantage in that it was difficult to replace bakelite, which is used as a sealing material in high-power capacitors.

### BRIEF SUMMARY OF THE INVENTION

At least one embodiment of the invention was created to solve the above-mentioned problems of the related art, and a technical problem of at least one embodiment of the invention is to provide a configuration of a sealing material for a capacitor that has rigidity sufficient to be used in a high-power capacitor, excellent insulation properties, and in particular, can replace the known bakelite used as a sealing material for a high-power capacitor.

In order to achieve the above-described technical problem, a sealing material for a capacitor of one or more embodiments of the invention is configured to include a disc made of metal, a coated body coated on an outer peripheral surface of the disc, and a hole formed in the coated body and through which a lead wire passes.

According to the sealing material for a capacitor of at least one embodiment of the invention having the above configuration, it is possible to achieve the excellent insulation properties by coating the outer peripheral surface of the disc with a coating part made of a rubber material.

In addition, it is possible to replace bakelite used in the conventional high-power capacitors.

In addition, by forming the protruding part on the disc made of metal to increase the rigidity of the sealing material itself, it is possible to apply the sealing material for a capacitor to the high-power capacitors

In addition, since a portion of the surface of the disc is exposed to the upper surface of the sealing material, the bias or inclination of the disc can be confirmed with the naked eye, so it is possible to facilitate the quality control.

### BRIEF DESCRIPTION OF THE DRAWINGS

FIG. 1 is a perspective view of a sealing material for a capacitor having a conventional reinforcing material.

FIG. 2 is a plan view of the sealing material according to one or more embodiments of the invention.

FIG. 3 is a cross-sectional view of the sealing material according to one or more embodiments of the invention.

FIG. 4 is a perspective view of a disc of the sealing material according to one or more embodiments of the invention.

FIG. 5 is a plan view of the disc of the sealing material according to one or more embodiments of the invention.

FIG. 6 is a cross-sectional view of the disc of the sealing material according to one or more embodiments of the invention.

FIG. 7 is a plan view of a sealing material according to one or more embodiments of the invention.

FIG. 8 is a cross-sectional view of the sealing material according to one or more embodiments of the invention.

FIG. 9 is a perspective view of the disc of the sealing material according to one or more embodiments of the invention.

FIG. 10 is a plan view of the disc of the sealing material according to one or more embodiments of the invention.

FIG. 11 is a cross-sectional view of the disc of the sealing material according to one or more embodiments of the invention.

FIGS. 12A and 12B are a usage state diagram in a state in which a chamfering process is not performed on the sealing material according to one or more embodiments of the invention and a usage state diagram in a state in which the corresponding chamfering process is performed.

FIGS. 13A and 13B are a usage state diagram in a state in which a protrusion of a hole has not been formed in the sealing material according to one or more embodiments of the invention and a usage state diagram in a state in which the protrusion of the hole has been formed.

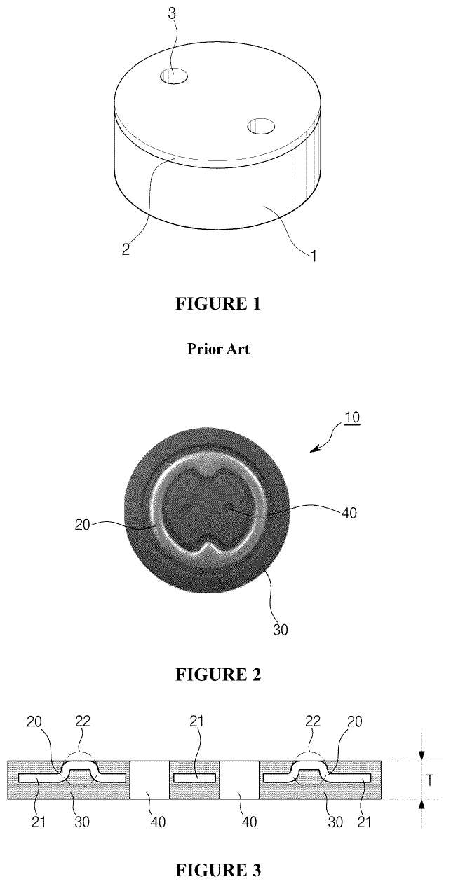

### DETAILED DESCRIPTION OF THE INVENTION

Hereinafter, a configuration of a sealing material for a capacitor with a disc of at least one embodiment of the invention will be described with reference to the drawings.

However, the drawings disclosed are provided by way of example so that the spirit of at least one embodiment of the invention may be sufficiently transferred to those skilled in the art. Therefore, at least one embodiment of the invention is not limited to the drawings to be provided below, but may be implemented in other forms.

In addition, the terms used in the specification of one or more embodiments of the invention have the general meaning understood by those skilled in the art to which the one or more embodiments of the invention pertains unless otherwise defined, and a detailed description for the known function and configuration unnecessarily obscuring the gist of on or more embodiments of the invention will be omitted in the following description and the accompanying drawings.

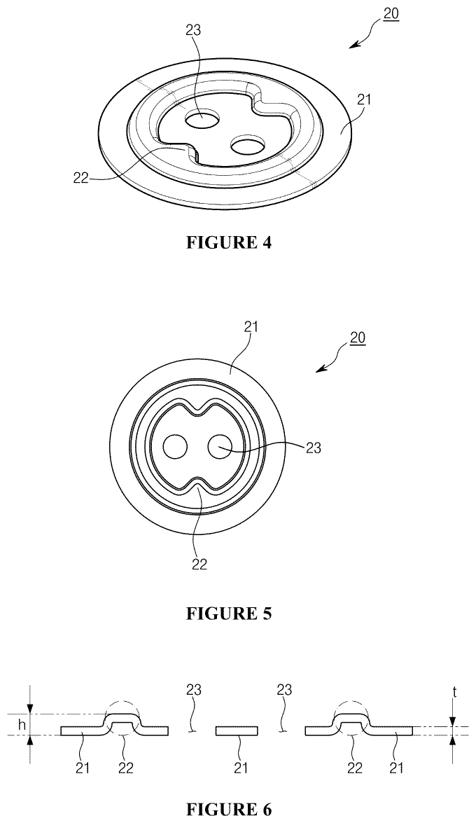

FIG. 2 is a plan view of a sealing material according to one or more embodiments of the invention, FIG. 3 is a cross-sectional view of the sealing material according to one or more embodiments of the invention, FIG. 4 is a perspective view of a disc of the sealing material according to one or more embodiments of the invention, and FIG. 5 is a plan view of the disc of the sealing material according to one or more embodiments of the invention.

Referring to each drawing, a sealing material 10 for a capacitor of at least one embodiment of the invention is formed by coating an outer peripheral surface of a surface and a back surface of a disc 20 with a coated body 30, and a hole 40 through which a lead wire of the capacitor passes is perforated in a center of the coated body 30.

In addition, the disc 20 is formed with a body 21 in the shape of a flat plate and a protruding part 22 protruding upward on the surface of the body 21.

The protruding part 22 is formed in a circular closed curve shape extending along a circumference of the body 21, and a through hole 23 through which the lead wire having passed the hole 40 of the coated body 30 passes is formed in the center of the body 21.

In this case, an upper surface of the protruding part 22 is processed so as not to be covered by the coated body 30, so an upper surface of the protruding part 22 is exposed to an upper surface of the sealing material 10.

Preferably, the disc 20 is made of a stainless steel material, and the coated body 30 is made of a rubber material.

Meanwhile, in at least one embodiment of the invention, the disc 20 has a thickness t of 0.8 mm and a total height h formed to be 2.0 mm, and the coated body 30 has a thickness T formed to be 3.0±0.1 mm.

The stainless steel is steel containing elements such as chromium, carbon, nickel, tungsten, vanadium, copper, and silicon, and has the characteristics of being rigid and having excellent corrosion resistance and rust prevention.

Meanwhile, in addition to the stainless steel, as the material of the disc 20, any one of aluminum, titanium, and carbon fiber may be used.

The rubber material of the coated body 30 may be a synthetic rubber material using isobutylene-isoprene rubber (IIR) as a main ingredient, and in a raw material injection step, the rubber material is performed to have a thickness to be used for the sealing material, so that the rubber material is coated on the surface and back surface of the disc 20.

Meanwhile, as the rubber material of the coated body 30, any one of natural rubber (NR), styrene butadiene rubber (SBR), ethylene propylene diene monomer (EPDM), polybutadiene rubber (BR), nitrile butadiene rubber (NBR), silicone rubber (Q), acrylic elastomers (ACM, ANM), fluoroelastomers (FPM), hydrogenated nitrile rubber (HNBR), polyurethane (UR), and thermoplastic elastomer (TPE) may also be used.

Therefore, the sealing material 10 of at least one embodiment of the invention has the coated body 30 of the rubber material covering the periphery of the hole 40 on a flat surface, so the insulation property with the lead wire passing through the hole 40 is secured.

In addition, the disc 20 inserted into the sealing material 10 is shaped so that its rigidity increases by the protruding part 22 formed in the body 21, thereby preventing the shape change of the sealing material 10 due to internal pressure.

In addition, since the upper surface of the protruding part 22 of the disc 20 is exposed to the upper surface of the sealing material 10, the bias and inclination of the disc 20 inserted can be confirmed with the naked eye, so that quality control may be easily performed.

Table 1 below shows the results of measuring the flexural strength of the disc 20 used in the sealing material 10 of one or more embodiments of the invention. As the comparative examples, the flexural strengths of the sealing material (Comparative Example 1) made of a synthetic material of rubber and phenol resin and a sealing material (Comparative Example 2) made of steel metal such as SUS 304 were measured together.

Referring to Table 1, the disc 20 used in the sealing material of at least one embodiment of the invention showed a 79% improvement in a transverse flexural strength compared to the sealing material made of steel metal, and a 94% improvement in the longitudinal flexural strength compared to the sealing material made of steel metal, so the sealing material 10 of one or more embodiments of the invention, which has the disc 20 inserted, obtained an excellent rigidity effect.

In addition, the deposition test of the sealing material 10 of at least one embodiment of the invention was performed, and the results are shown in Table 2 below, and as a comparative example, the deposition test of the sealing material (Comparative Example 1) made of a synthetic material of rubber and phenol resin was also performed.

Referring to Table 2 above, the change amount after the deposition of the sealing material of at least one embodiment of the invention is significantly lower than that of Comparative Example 1, and therefore, it can be seen that almost no deposition occurs in the sealing material itself, indicating that it is excellent in preventing electrolyte leakage.

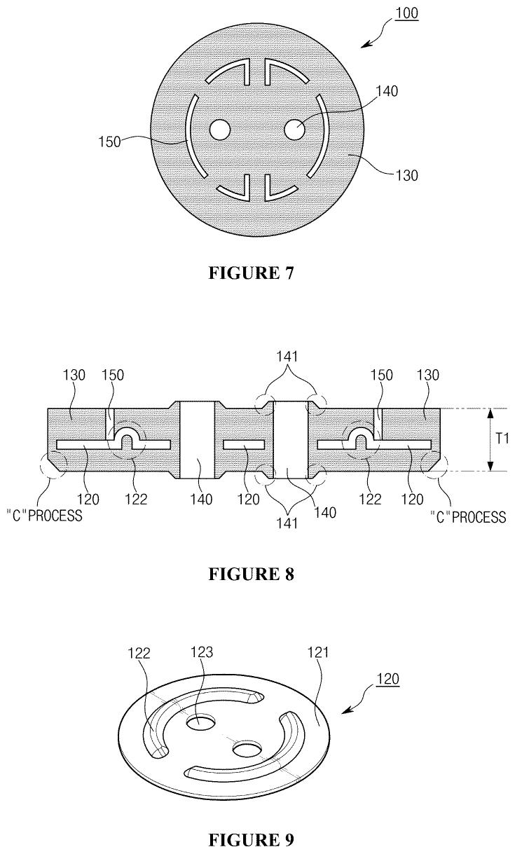

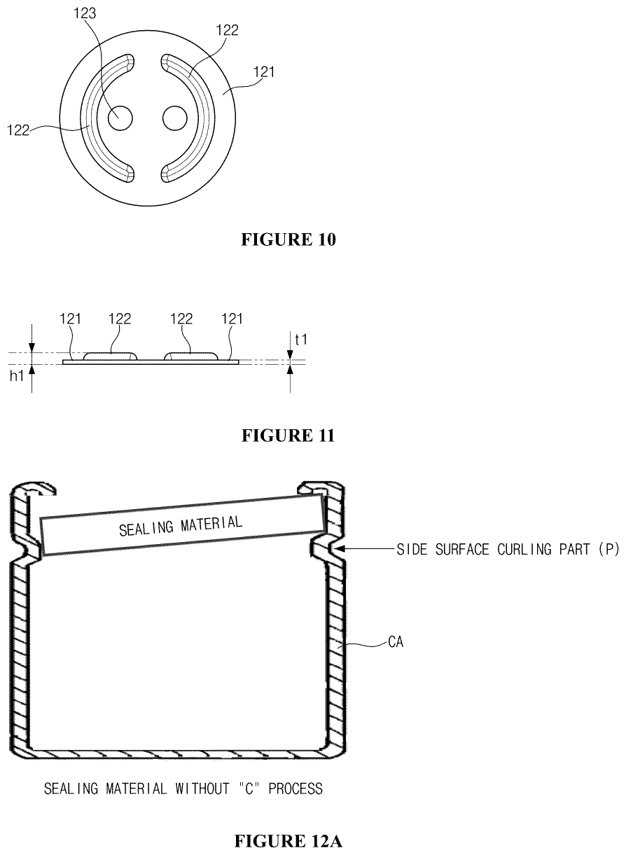

FIG. 7 is a plan view of a sealing material according to one or more embodiments of the invention, FIG. 8 is a cross-sectional view of the sealing material according to one or more embodiments of the invention, FIG. 9 is a perspective view of a disc of the sealing material according to one or more embodiments of the invention, FIG. 10 is a plan view of a disc of the sealing material according to one or more embodiments of the invention, and FIG. 11 is a cross-sectional view of the disc of the sealing material according to one or more embodiments of the invention.

A sealing material 100 according to at least one embodiment of the invention is configured such that an outer peripheral surface of a surface and a back surface of a disc 120 is coated with a coated body 130, a hole 140 through which a lead wire of a capacitor passes is perforated in a center of the coated body 130, a groove 150 is formed so as to have a predetermined depth from an upper surface of the coated body 130, and an upper surface of the disc 120 is exposed through the groove 150.

In addition, the disc 120 is formed with a body 121 in the shape of a flat plate and a protruding part 122 protruding upward on the surface of the body 121.

The protruding part 122 is formed in a circular curve shape with a portion of the body 121 extending along a circumference of the body 121 open, and unlike the above-described embodiment, the upper surface of the protruding part 122 is covered with the coated body 130.

In addition, a through hole 123 is formed to pass the lead wire having passed through the hole 140 in the center of the body 121 of the disc 120.

As with the protruding part 122, the groove 150 is formed in a circular curve shape with a part of the body 121 extending along the circumference of the body 121 open.

Preferably, the disc 120 is made of a stainless steel material, and the coated body 130 is made of a rubber material.

Meanwhile, in at least one embodiment of the invention, the disc 120 has a thickness t1 of 0.8 mm and a total height h1 formed to be 1.7 mm, and the coated body 30 has a thickness T1 from the surface to the back surface formed to be 3.0 mm.

In addition to the stainless steel, as the material of the disc 120, any one of aluminum, titanium, and carbon fiber may be used.

As with the above-described one or more embodiments, the rubber material of the coated body 130 may be a synthetic rubber material using isobutylene-isoprene rubber (IIR) as a main ingredient, and in a raw material injection step, the rubber material is performed to have a thickness to be used for the sealing material, so that the rubber material is covered on the surface and back surface of the disc 120.

Meanwhile, as the rubber material of the coated body 30, any one of natural rubber (NR), styrene butadiene rubber (SBR), ethylene propylene rubber (EPDM), polybutadiene rubber (BR), nitrile butadiene rubber (NBR), silicone rubber (Q), acrylic elastomers (ACM, ANM), fluoroelastomers (FPM), hydrogenated nitrile rubber (HNBR), polyurethane (UR), and thermoplastic elastomer (TPE) may also be used.

Therefore, the sealing material 100 of at least one embodiment of the invention has the coated body 130 of the rubber material covering the periphery of the hole 140 on a flat surface, so the insulation property with the lead wire passing through the hole 140 is secured.

In addition, the disc 120 inserted into the sealing material 100 is shaped so that its rigidity increases by the protruding part 122 formed in the body 121, thereby preventing the shape change of the sealing material 100 due to internal pressure.

In addition, the sealing material 100 of at least one embodiment of the invention is configured such that the upper surface of the disc 120 is exposed through the groove 150 on the upper surface, so that the bias and inclination of the disc 120 inserted may be confirmed with the naked eyes, thereby making it easy to perform quality control.

In addition, the sealing material 100 of at least one embodiment of the invention is chamfered (so-called “C” processing) in a slanted shape from the side surface of the coated body 30 toward the bottom surface on the lower corner portion of the coated body 130.

By performing the chamfering process on the lower corner portion of the coated body 130, the sealing material 100 may be easily joined to a side surface Curling part P inside a case CA of the capacitor, thereby improving the productivity and yield of the capacitor.

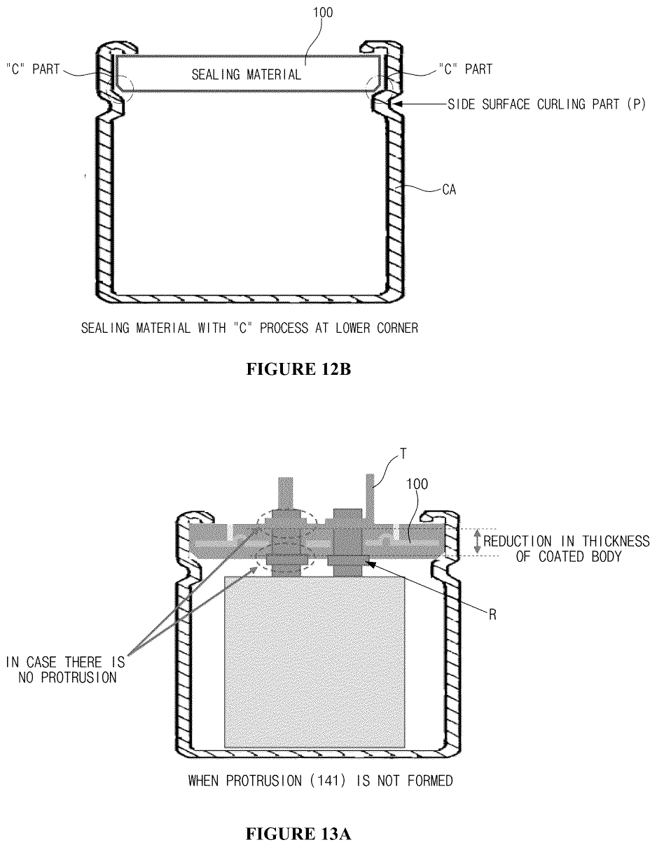

That is, in the case where the lower corner portion of the coated body 130 is not chamfered, as shown in FIG. 12A, when the sealing material 100 is inserted into the upper portion of the case CA of the capacitor, the lower portion of the coated body 130 made of a rubber material may slide along a tilted surface of the side surface Curling part P of the case CA, causing the sealing material 100 to be attached at an angle, which may reduce productivity and yield. However, in the case where the lower corner portion of the coated body 130 is chamfered, as shown in FIG. 12B, the lower portion of the coated body 130 is accurately joined to the side surface Curling portion P inside the case CA, thereby improving productivity and yield. Furthermore, as the chamfered portion of the lower part of the coated body 130 expands the contact surface with the side surface Curling portion P inside the case CA, the airtightness of the sealing material 100 is also improved.

In addition, the sealing material 100 of at least one embodiment of the invention has a protrusion 141 formed so that an edge portion of the hole 140 of the coated body 130 protrudes upward from the surface of the coated body 130.

When a terminal T is coupled to the upper side of the hole 140 of the surface of the sealing material 100 and a rivet R is coupled to the lower side of the hole 140 of the back surface of the sealing material 100, the protrusion 141 supports the pressing force of the terminal T and the rivet R when they are pressed, thereby preventing the phenomenon in advance in which the terminal T and the rivet R dig into the inside of the sealing material 100.

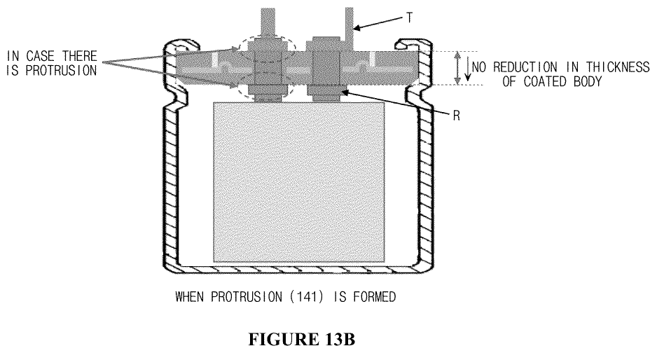

That is, in the case where the protrusion 141 is not formed on the edge portion of the hole 140, as shown in FIG. 13A, the pressing force when the terminal T and the rivet R are pressed causes the terminal T and the rivet R to dig into the inside of the rubber of the coated body 130 of the sealing material 100, so the thickness of the coated body 130 at the pressing portion of the terminal T and the rivet R becomes thin. However, in the case where the protrusion 141 is formed on the edge portion of the hole 140, as shown in FIG. 13B, the protrusion 141 formed on the edge portion of the hole 140 supports the pressing force when the terminal T and the rivet R are pressed, thereby preventing the terminal T and the rivet R from digging into the inside of the sealing material 100, so the thickness of the coated body 130 at the pressing portion of the terminal T and the rivet R does not become thin. As a result, not only is the airtightness of the sealing material 100 improved, but also the thickness of the sealing material 100 does not need to be formed thick, thereby allowing for the further increase in the capacity of the capacitor while improving the freedom in the internal space of the capacitor.

### DESCRIPTION OF SYMBOLS

### Explanation of Symbols for Major Parts of Drawing

10: Sealing material of at least one embodiment of the invention
20: Disc
21: Body
22: Protruding part
23: Through hole
30: Coated body
40: Hole
100: Sealing material of at least one embodiment of the invention
120: Disc
121: Body
122: Protruding part
123: Through hole
130: Coated body
140: Hole
141: Protrusion
150: Groove

1-8. (canceled)

9. A sealing material for a capacitor, comprising:
a disc made of metal;
a coated body coated on an outer peripheral surface of the disc; and
a hole formed in the coated body and through which a lead wire passes.

10. The sealing material of claim 9, wherein the disc comprises:
a body in a shape of a flat plate;
a protruding part protruding upward from a surface of the body; and
a through hole formed in a center of the body,
wherein an upper surface of the protruding part is processed so as not to be covered by the coated body so that the upper surface of the protruding part is exposed to the upper surface of the sealing material.

11. The sealing material of claim 10, wherein the metal is a stainless steel material, and the coated body is made of rubber.

12. A sealing material for a capacitor, comprising:
a disc made of metal;
a coated body coated on an outer peripheral surface of the disc; and
a hole formed in the coated body and through which a lead wire passes,
wherein a groove is formed to have a predetermined depth from an upper surface of the coated body, and an upper surface of the disc is exposed through the groove.

13. The sealing material of claim 12, wherein the disc comprises:
a body in a shape a flat plate;
a protruding part protruding upward from a surface of the body; and
a through hole formed in a center of the body,
wherein an upper surface of the protruding part is covered by the coated body.

14. The sealing material of claim 13, wherein the metal is a stainless steel material, and the coated body is made of rubber.

15. The sealing material of claim 13, wherein a chamfering process is performed in a slanted shape from a side surface of the coated body toward a bottom surface at a lower corner portion of the coated body.

16. The sealing material of claim 13, wherein a protrusion is formed on an edge portion of the through hole of the coated body so as to protrude upward from a surface of the coated body.
